(19) United States
(12) Patent Application Publication
(10) Pub. No.: US 2004/0198437 A1
(43) Pub. Date: Oct. 7, 2004

(54) Slide-type portable information apparatus

(75) Inventors: Atsushi Yamamoto, Tokyo (JP); Kiyoshi Kohayakawa, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 10/403,869

(22) Filed: Mar. 28, 2003

(30) Foreign Application Priority Data
Mar. 29, 2002 (JP) 2002-096333

(51) Int. Cl. H04M 1/00; H04B 1/38

(52) U.S. Cl. 455/556.1; 455/550.1

(57) ABSTRACT

A slide-type portable apparatus includes a front-side unit provided with at least a display and a secondary operation section and a back-side unit provided with at least a main operation section. The front-side unit is coupled with the back-side unit to freely slide in a longitudinal direction between a retracted state and an extended state. A position detector detects a relative position of the front-side unit and the back-side unit. Input function allocation to the main operation section and the secondary operation section is changed depending on the relative position.

### BACKGROUND OF THE INVENTION

1. Field of the Invention

The present invention relates to a portable information apparatus such as a portable telephone and more particularly to a portable information apparatus having a slide-type structure.

2. Description of the Related Art In addition to a straight-type portable telephone apparatus, foldable or slidable structures have been employed to meet the needs for miniaturization. The foldable structure allows two units of a main body to be folded by a connecting member rotatably connecting the two units. The slidable structure is provided with a main housing (first unit) and a movable housing (second unit), which is mounted with a part of functions and is coupled with the main housing so as to be slidable in the longitudinal direction. Such a structure allows the two units to be retracted with overlapping one another when carried and to be extended by sliding them in the longitudinal direction when communicating or the like.

There have been known many slide-type structures, which are adapted so that a movable housing is accommodated within a main housing. For example, in Japanese Patent Application Unexamined Publication No. 10-271192, a portable phone terminal has been disclosed, in which an operation panel portion having a microphone and a group of dial operation keys can slide into the main body having a speaker and a display. In this portable phone terminal, when being accommodated in the main body, the operation panel section is covered with the main body and therefore cannot be used, preventing it from operating errors.

In a radio telephone disclosed in Japanese Patent Application Unexamined Publication No. 2000-506323, the operation keys provided on a main body can be covered with a sliding cover. When the sliding cover slides in the longitudinal direction, some keys are exposed and these exposed keys can be operated to perform respective predetermined functions.

In general, when extended or opened, almost all keys can be operated. However, when closed or retracted, the number of keys allowed to be operated is very small. Multiple functions may be allocated to a single key that is always exposed. Alternatively, a sequence of operations of exposed key(s) may determine and perform a corresponding predetermined function as described in the above publication (No. 2000-506323).

However, it is cumbersome that a predetermined function is performed by a sequence of operations of exposed of keys. Further, in the above conventional slide-type portable telephones, predetermined functions are fixedly allocated to the respective operation keys. Accordingly, there are cases where a low-frequently used function is allocated to a high-operability key, resulting in reduced ease of use.

### SUMMARY OF THE INVENTION

An object of the present invention is to provide a slide-type portable communication apparatus allowing easy operation and enhanced convenience in use.

According to the present invention, allocation of plural functions to operation keys is changed depending on a position relationship between two sliding units.

According to an aspect of the present invention, a slide-type portable apparatus includes: a first unit having at least a display section and a secondary operation section; a second unit having at least a main operation section, wherein the first unit is coupled with the second unit to freely slide in a longitudinal direction between a retracted state and an extended state; a position detector for detecting a relative position of the first unit and the second unit; and a function change controller for changing input function allocation to the main operation section and the secondary operation section depending on the relative position.

one of the first unit and the second unit further may have a tertiary operation section, wherein the function change controller changes input function allocation to at least one of the main operation section, the secondary operation section, and the tertiary operation section depending on the relative position.

The slide-type portable apparatus may further include: an urging member for urging the first unit and the second unit in an extension direction; and a releasable lock mechanism for releasably locking the first unit and the second unit at a desired stop position between the retracted state and the extended state included, wherein the locking is released by a predetermined operation.

Preferably, the releasable lock mechanism releasably locks the first unit and the second unit in one of the retracted state and at least one half-opened state which is positioned between the retracted state and the extended state.

At least one of the first unit and the second unit may further have at least one optical input section exposed, wherein the function change controller changes input function allocation to at least one of the main operation section, the secondary operation section, and the at least one optical input section depending on the relative position.

Preferably, one of the first unit and the second unit has a first optical input section and a second input section placed in the longitudinal direction, wherein the function change controller allocates input function to an exposed one of the main operation section, the first optical input section, and the second input section depending on the relative position.

As an embodiment, the first optical input section is an optical input section of a fingerprint authentication device and the second input section is an optical aperture of an image pickup device.

Preferably, information indicating allocated input functions to the main operation section and the secondary operation section depending on the relative position is displayed on at least one part of the display section. The slide-type portable apparatus may further include a speaker which produces sound corresponding to an input operation, wherein a tone color of the sound is changed depending on the relative position.

Further, the slide-type portable apparatus may further include: a lighting section for lighting at least one of the main operation section and the secondary operation section lighting section depending on input function allocation to the main operation section and the secondary operation section.

According to another aspect of the present invention, an input function control method for the slide-type portable apparatus, includes the steps of: detecting a relative position of the first unit and the second unit; and changing input function allocation to the main operation section and the secondary operation section depending on the relative position.

A predetermined input function may be allocated to an exposed section of the main operation section and the secondary operation section. An input function allocated to an exposed section of the main operation section and the secondary operation section may be different from a normal input function allocated to the main operation section and the secondary operation section in the extended state.

### BRIEF DESCRIPTION OF THE DRAWINGS

FIG. 1A is a side view of a portable telephone apparatus in a retracted state where a front-side unit and a back-side unit overlap one another, according to a first embodiment of the present invention;

FIG. 1B is a plan view of the portable telephone apparatus of FIG. 1A;

FIG. 2A is a rear view of the portable telephone apparatus in a half-opened state where the front-side unit and the back-side unit slide in a longitudinal direction, according to the first embodiment of the present invention;

FIG. 2B is a side view of the portable telephone apparatus of FIG. 2A;

FIG. 2C is a plan view of the portable telephone apparatus of FIG. 2A;

FIG. 3A is a rear view of the portable telephone apparatus in an extended state where the front-side unit and the back-side unit extendedly slide in a longitudinal direction, according to the first embodiment of the present invention;

FIG. 3B is a side view of the portable telephone apparatus of FIG. 3A;

FIG. 3C is a plan view of the portable telephone apparatus of FIG. 3A;

FIG. 4 is an exploded perspective view of a slide mechanism in the first embodiment when viewed from above,

FIG. 5 is an Exploded perspective view of the slide mechanism in the first embodiment when viewed from below;

FIG. 6 is a schematic block diagram showing an electric circuit of the portable telephone apparatus according to the first embodiment;

FIG. 7A is a flowchart showing a control operation of function allocation setting in the first embodiment;

FIG. 7B is a diagram showing an example of a correspondence table between stop positions of the front-side and back-side units and function allocation settings;

FIG. 8A is a rear view of the portable telephone apparatus in an extended state where the front-side unit and the back-side unit extendedly slide in a longitudinal direction, according to a second embodiment of the present invention;

FIG. 8B is as view of the portable telephone apparatus of FIG. 8A; and

FIG. 8C is a plan view of the portable telephone apparatus of FIG. 8A.

### DESCRIPTION OF THE PREFERRED EMBODIMENTS

### First Embodiment

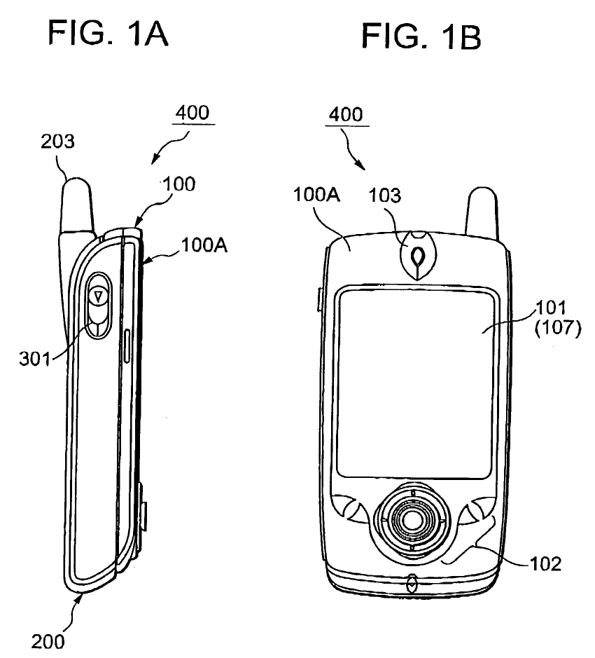

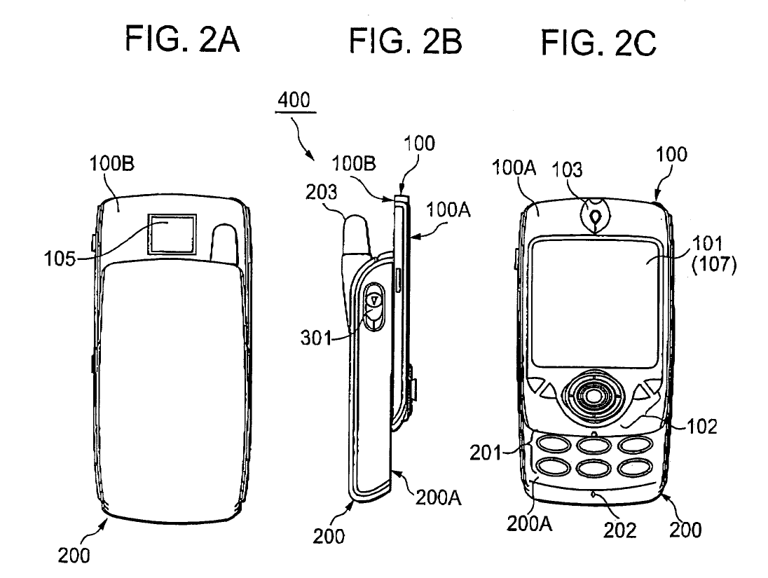

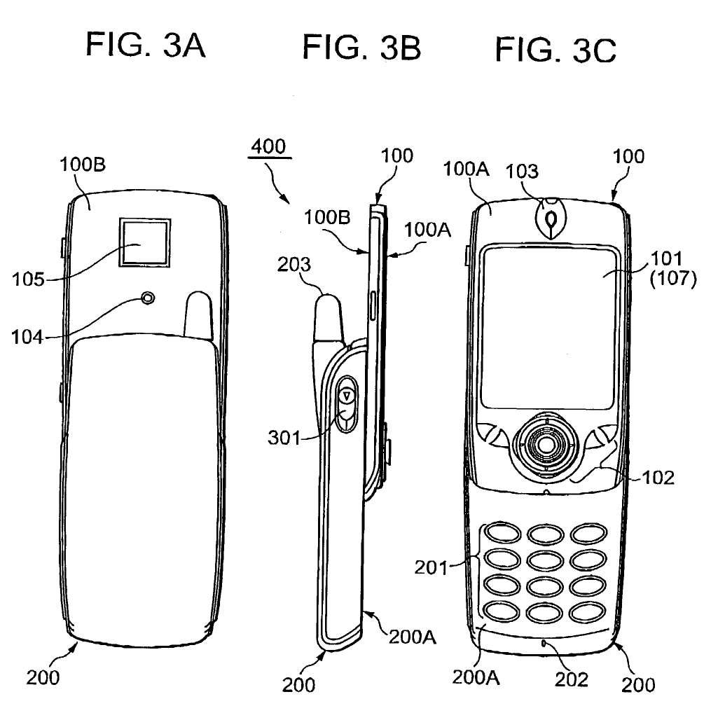

As shown in FIG. 1A-1B, FIGS. 2A-2C, and FIGS. 3A-3C, a portable telephone set according to a first embodiment of the present invention is composed mainly of a front-side unit (first unit) 100 and a back-side unit (second unit) 200, which are connected by a slide mechanism so that they are able to freely sliding in a longitudinal direction.

The front-side unit 100 is flat and roughly rectangular in form having a predetermined thickness, and has a first main surface 100A that is a front surface of the front-side unit. 100 and a first back surface 100B thereof. The front-side unit 100 has a large-size display section (LCD device) 101, a secondary operation section 102 composed of a four-direction operation key (up, down, left, right) and two menu keys for each side, and a receiver section (speaker) 103 provided on the first main surface 100A. On the first back surface 100B, the front-side unit 100 has an optical function section provided, for example, an optical aperture section (sensor section) of an electronic image pick-up device (e.g. CCD camera) 104 and a fingerprint input section (e.g. optical sensor) 105 as shown in FIG. 2A or 3A.

In the present embodiment, the fingerprint input section 105 is first exposed in the half-opened state as shown in FIG. 2A. The electronic image pick-up device 104 is then exposed in the extended state as shown in FIG. 3A.

Further, a magnet 106 (not shown) is disposed at an appropriate position on the first back surface 100B and a plurality of magnetic sensors 210a and 210b (not shown) are disposed at appropriate positions on the second main surface 200A. As will be described later, the magnet 106 and the magnetic sensors 210a and 210b are used by an extension detector 211 to detect the relative position of the units 100 and 200. In the display section 101, a touch panel mechanism 107 may be incorporated.

The back-side unit 200 is flat in form, which has the approximately same shape as the front-side unit 100, and is mounted to the rear side of the front-side unit 100 so as to be freely slidable. A second main surface 200A that is a front surface of the back-side unit 200 has a main operation section 201 and a transmitter section (microphone) 202 provided on the lower portion thereof as shown in FIG. 3C. A stop-release operation member (one touch slide button) 301 is provided on one side surface of the back-side unit 200. Within the back-side unit 200, other electronic circuits are accommodated, which will be described later. The stop-release operation member 301 and its mounting section may be made of optically transparent material such as transparent or translucent resin or silicone rubber.

Both units 100 and 200 are urged in an extending direction by an urging means 302 disposed within the portable telephone set so as to keep the extended or half-opened state. In addition, a stop means (locking mechanism) is provided to lock the units 100 and 200 so as to keep the half-opened or retracted state of the units against the urging means 302. The locking of the stop means can be released by operating the stop-release operation member 301 disposed on one of the side surfaces of the back-sides unit 200.

In this embodiment, when the stop-release operation member 301 slides, the lock mechanism of the front-side unit 100 and back-side unit 200 is released to cause the front-side unit 100 to automatically slide upward with respect to the back-side unit 200 by the urging means 302 to set the telephone set in a usable state that the front-side unit 100 and the back-side unit 200 are opened or half-opened. Instead of sliding the stop-release operation member 301, the stop-release operation member 301 may be depressed to release the lock mechanism.

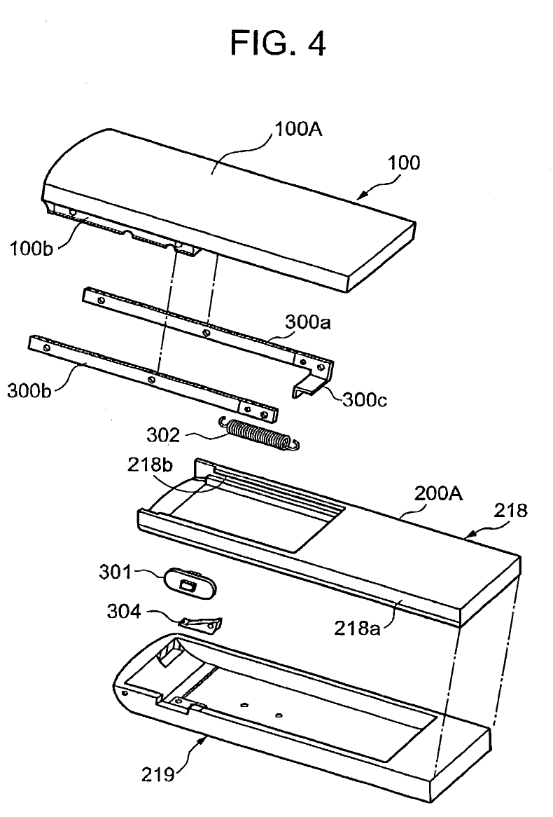

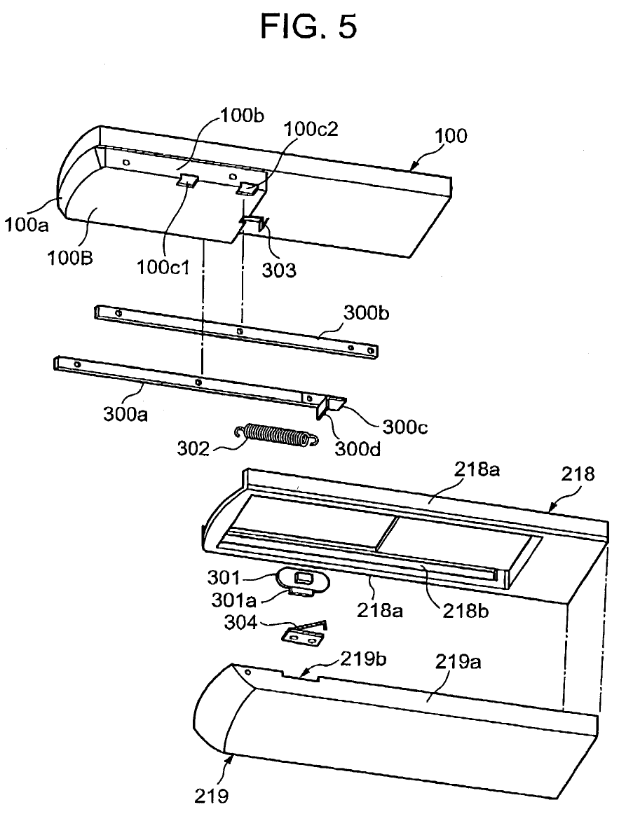

Referring to FIGS. 4 and 5, the upper portion of the front-side unit 100 (left side in the figure) is formed in a swelling shape toward the back-side, and this swelling portion 100a has guide rails 300a and 300b mounted to respective ones of both side surfaces 100b, 100b so that the lower portions of the guide rails extend from the swelling portion 100a downwardly (to right direction in the figure). The end of the lower portion of the guide rail 300a has a roughly L-shaped bracket 300c fixed thereto. At the center of the bracket in the axial direction, the edge of the bracket 300c is bent downward in the figure to form an engagement piece 300d. At the central portion of the lower end of the swelling portion 100a, a stop protrusion piece 303 is provided as a stopper in the extension direction. At the center of the one side edge of the swelling portion, stop recess portions 100c1 and 100c2 are formed. One end of a coil spring 302 is fixed to the engagement piece 300d and the other end is fixed to the bottom surface of the back case 219 such that the coil spring 302 is disposed in parallel with the guide rail 300a.

The back-side unit 200 is composed of an intermediate frame 218 and the back case 219 coupled with the intermediate frame 218. Guide grooves 218b and 218b for guiding respective ones of the guide rails 300a and 300b are formed in the inner sides of the respective side walls 218a, 213a of the intermediate frame 218. The lower portion of the front surface of the intermediate frame 218 is provided for the second main surface 200A where the main operation section 201 is formed.

The back case 219 has a stop spring 304 of roughly “<”-like shape fixed at the position corresponding to the stop recess portion 100c1 or 100c2. When the units 100 and 200 are retracted, the free end of the Shop spring 304 enters into the stop recess portion 100c1 to restrain the front-side unit 100 from moving in the extension direction. When the units 100 and 200 are half-opened, the free end of the stop spring 304 enters into the stop recess portion 100c2 to restrain the front-side unit 100 from moving in the extension direction.

A notch portion 219b is formed in the sidewall 219a of the back case 219 at a position corresponding to the mounting position of the stop spring 304. The stop-release operation member 301 is engaged with this notch portion 219b so as to be slidable by a minute distance in the axial direction. The inwardly protruding piece 301a of the stop-release operation member 301 is adapted so as to come in contact with the upper slope of the stop spring 304, and tension by the stop spring 304 urges the stop-release operation member 301 toward the upper end of the portable telephone set.

The front-side unit 100 and back-side unit 200 are urged in the extension direction by the coil spring 302 at all times. When both units are slid in the retraction direction against the tension of the coil spring 302, the front edge of the free end of the stop spring 304 is inserted into the stop recess portion 100c1 or 100c2 to restrain both units from moving toward the extension direction, thereby keeping the retracted or half-opened state. It is more preferable that an appropriate braking means is provided to act in parallel with the coil spring 302, or an appropriate braking element is incorporated into the urging means itself so that the both units slide slowly.

When downwardly sliding the stop-release operation member 301 in the retracted state, the inwardly protruding piece 301a moves while keeping the contact with the upper slop of the stop spring 304 to lower the front edge of the free end of the stop spring 304. When the front edge of the free end of the stop spring 304 is disengaged from the stop recess portion 100c1 or 100c2, the tension of the coil spring 302 causes the both units to slide in the extension direction. In this manner, portable telephone set is automatically extended from the retraction, state to the extension or half-open state by only sliding the stop-release operation member 301.

In the present embodiment, a magnet 106 (not shown) is disposed at an appropriate portion in the front-side unit 100 in order to cooperate magnetic sensors to determine whether the two units are in the retracted, half-opened, or extended state. In this embodiment, two magnetic sensors 210a and 210b (e.g. Hole element or the like) are disposed in the back-side unit 200, for example, at a first position facing the magnet 106 in the retracted state and a second position facing in the half-opened state. Since a predetermined output of the magnetic sensor 210a or 210c is obtained by the magnetic field of the magnet 106, the retracted or half-opened state can be detected.

As described above, according to the present embodiment, the sliding amount of the two units 100 and 200 can be changed in two steps. When the stop-release operation member 301 is simply slid in the retracted state in which the front-side and back-side units overlap one another as shown in FIGS. 1A and 1B, the front-side unit slides upwardly from the back-side unit into the half-opened state as shown in FIGS. 2A-2C. In the half-opened state as shown in FIGS. 2A-2C, the lower-half operation keys of the operation keys 201 and the fingerprint input section 105 are exposed, allowing the user to operate these exposed keys in addition to the secondary operation section 102 and input the user's fingerprint. In the half-opened state, the image pickup device 104 is still covered with the back-side unit 200 and therefor the camera function is not used.

When the stop-release operation member 301 is further slid in the half-opened state, the front-side unit further slides upwardly from the back-side unit into the extended state in which the main operation section 201 and the image pickup device 104 are exposed as shown in FIGS. 3A-3C, allowing the user to operate all the operation keys and use all functions including the camera function.

Next, an electric circuit of the portable telephone according to the present embodiment will be described.

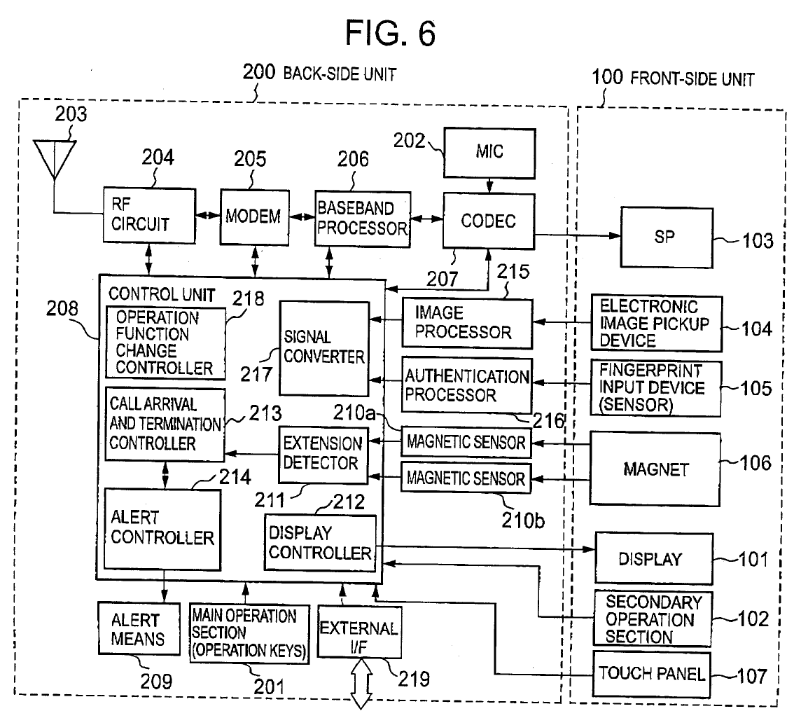

As shown in FIG. 6, the front-side unit 100 of the portable telephone is mounted with the display section (LCD) 101, the secondary operation section (secondary operation keys) 102, the receiver (speaker) 103, the electronic image pickup device (CCD camera) 104, the fingerprint input device (sensor) 105, the magnet 106 used to detect a relative position of the front-side unit 100 and the back-side unit 200, and the touch panel 107 incorporated in the display section 101.

In addition, the back-side unit 200 is mounted with an antenna 203, an RF circuit 204, a modem 205, a baseband processing circuit 206, a codec circuit 207, a control unit 208, the microphone 202, the main operation keys 201, an alert means 209, an image processor 215, an authentication processor 216, the magnetic sensors (Hole elements) 210a and 210b corresponding to the magnet 106, and an external interface section 219.

The control unit 208 includes an extension detector 211 that detects a relative position state of the units 100 and 200 based on detection outputs of the magnetic sensors 210a and 210b, a display controller 212 that controls the displaying of the display section 101, a call arrival and termination controller 213 that can carry out a call arrival control operation, an alert controller 214 that can control a call arrival notification, a signal converter 217 that performs conversion of signals from the image processor 215 and the authentication processor 216, and an operation function change controller 218. In addition, the back-side unit 200 is mounted with a memory (not shown) storing function allocation settings, which are used by the operation function change controller 218.

The RF circuit 204 has a receiving circuit, a transmitting circuit, and a frequency synthesizer, which are not shown. The operation keys 201 includes a transmission key, conversion keys for alphabet/Kana/Kanji/numeral, a power source on/off key, a cross key for cursor operation, and an end key. These functional sections are mounted within the back-side unit 200 or on the surface thereof. Each circuit block as shown in FIG. 6 may use a known one and therefore the detailed descriptions will be omitted.

As described before, when the front-side unit 100 and the back-side unit 200 are extended, the optical aperture section of the electronic image pickup device 104, the fingerprint input device 105, and the operation section 201 are exposed and operable as shown in FIGS. 3A-3C. Accordingly, only when extended, both the image capturing and fingerprint inputting functions can be available and speech communication is further allowed because the microphone and the receiver are appropriately separated from one another.

On the other hand, in the retracted state, the image pickup device 104 and the fingerprint input device 105 are protected and the main operation section 201 is prevented from operating errors. However, in the half-opened state, the lower-half keys of the main operation section 201 and the fingerprint input device 105 are exposed and operable.

In this embodiment, the secondary operation section 102 is provided on the first main surface 100A of the front-side unit 100, allow various operations including mail operation, image operation and call arrival operation while confirming visually the displayed contents on the display section in the retracted state.

A function changing operation of the portable telephone according to the embodiment will be described hereinafter. Other functions including telephone function or data communication function are known well and therefore the detailed descriptions will be omitted.

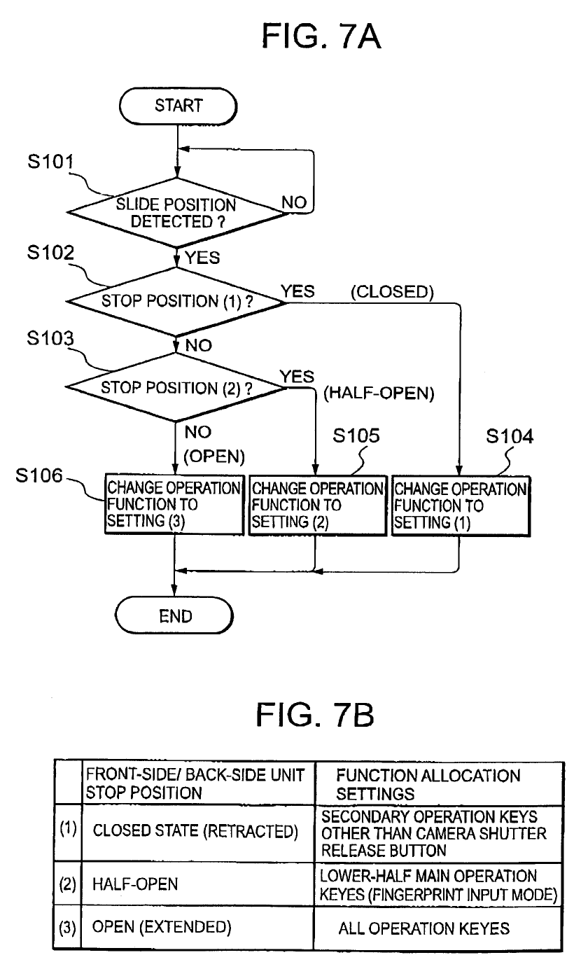

As shown in FIG. 7B, the function allocation settings are previously stored in the memory (not shown) the function allocation settings each corresponding to an closed (retracted) state, a half-opened state, and an open (extended) state of the stop position between the front-side unit 100 and the back-side unit 200. For example, depending on a current stop position, the operation function change controller 218 changes function allocation to operation keys by referring to the memory storing the function allocation settings.

As shown in FIG. 7A, the extension detector 211 of the control unit 208 monitors sensor outputs of the magnetic sensors 210a and 210b to detect a current slide position of the front side and back-side units (step S101). When the extension detector 211 detects the current position (YES at step S101), it is determined whether the detected position is a stop position (1) indicating the retracted state (stop S102).

When the detected position is the stop position (1) (YES at step S102), the operation function change controller 218 searches the memory to set the function allocation setting to the setting (1) allocating necessary functions to the exposed secondary operation keys 102 other than a camera shutter release button (step S104). Since the image pickup device 104 and the fingerprint input device 105 are covered with the back-side unit 200, the camera shutter release button is not functioned but the other keys of the secondary operation keys 102. In addition, the operation function change controller 218 controls the display controller 212 to display function descriptions each corresponding to the secondary operation keys 102 on at least apart of the display section 101, resulting in enhanced ease of use.

When it is not the stop position (1) (NO at step S102), it is determined whether the detected position is a stop position (2) indicating the half-opened state (step S103)

When it is the stop position (2) (YES at step S103), the operation function change controller 218 searches the memory to set the function allocation setting to the setting (2) allocating necessary functions to the exposed lower-half keys of the main operation keys 201 (step S105). Since the image pickup device 104 is covered with the back-side unit 200 and the fingerprint input device 105 is exposed, the camera shutter release button is not functioned but a fingerprint registration button of the exposed lower-half keys of the main operation keys 201. Therefore, the portable telephone is changed into the finger-print input permission mode when half-opened. Here, the fingerprint registration button is allocated to the numeral “0” button positioned at the center of the lowest key line in the main operation keys 201. In addition, the operation function change controller 218 controls the display controller 212 to display function descriptions each corresponding to the exposed lower-half main operation keys on at least a part of the display section 101. The exposed lower-half main operation keys other than the fingerprint registration button may be used for radio transmission and reception of data or for data transmission to an external equipment such as a personal computer using the external interface 219.

When it is not the stop position (2) (NO at step S103), it is determined that the current stop position is the opened state. The operation function change controller 218 sets the function allocation setting to the setting (3) allocating necessary functions to the all operation keys (step S106). Since both the image pickup device 104 and the fingerprint input device 105 are exposed, the camera shutter release button and the fingerprint registration button are allocated to normally determined operation keys. In other words, the numeral “0” button is functionally changed from the fingerprint registration button to the normal numeral “0”. Accordingly, the ten-key of the main operation keys 201 is used to dial for telephone calling. Another operation such as the fingerprint registration by the finger authentication processor 216 or data communication through the external interface 219 may be performed by operating a menu button of the secondary operation keys 102 before operating a corresponding predetermined button of the main operation keys 201 or operating a scroll button.

Another function allocation to keys may be employed. For example, in the case of Web connection mode, when the units 100 and 200 are retracted as shown in FIGS. 1A and 1B, four key-input operation functions: up-scroll, down-scroll, page (next) and page (back), are allocated to the four-direction operation key of the secondary operation key 102.

When the units 100 and 200 are half-opened as shown in FIGS. 2A-2C, four key-input operation functions: up-scroll, down-scroll, reduced size (small font) and enlarged size (large font), are allocated to the four-direction operation key of the secondary operation key 102. In this case, the key-input operation functions of page (next) and page (back) are allocated to exposed operation keys (lower-half operation keys) of the main operation keys 201.

As described before, it is preferably to display descriptions of the function allocation to the keys on at least a part of the display section 101, resulting in enhanced ease of use.

In the case where the sound of the speaker 103 can be controlled by input operations, it is possible to control the alert controller to change the output sound or tone of the speaker 103 depending on the above-described function allocation change or the stop position.

Further, the portable telephone may be provided with an lighting means and a lighting controller (not shown) The lighting means lights the key operation section from inside when operating keys. In such a case, it is possible to control the lighting controller to change the lighting condition (e.g. color and/or light intensity) of the lighting means depending on the above-described function allocation change or the stop position.

In the above-described embodiment, the portable telephone is changed into the half-opened state by the first sliding operation of the stop-release operation member 301 to expose the fingerprint input device 105 (fingerprint registration mode), and then by the second sliding operation, the portable telephone is changed into the extended state to also expose the image pickup device 104 (image pickup mode). However, it is possible that the image pickup device 104 is exposed when half-opened and then the fingerprint input device 105 is further exposed when extended. In other words, when half-opened, the portable telephone is changed into the image pickup mode and, when extended, into the fingerprint registration mode.

The key operation section of the portable telephone is not limited to the main operation keys 201 and the secondary operation keys 102. A tertiary operation keys (not shown) may be provided on, for example, one side of the front-side unit or the back-side unit. The operation function change controller 218 changes the function allocation among at least one of the main operation keys 201, the secondary operation keys 102 and the tertiary operation keys. The tertiary operation keys may include the stop-release function as described before.

Furthermore, in the above embodiment, the sliding amount of the two units 100 and 200 is changed in two steps. It is possible to change the sliding amount of the two units 100 and 200 in three or more steps.

### Second Embodiment

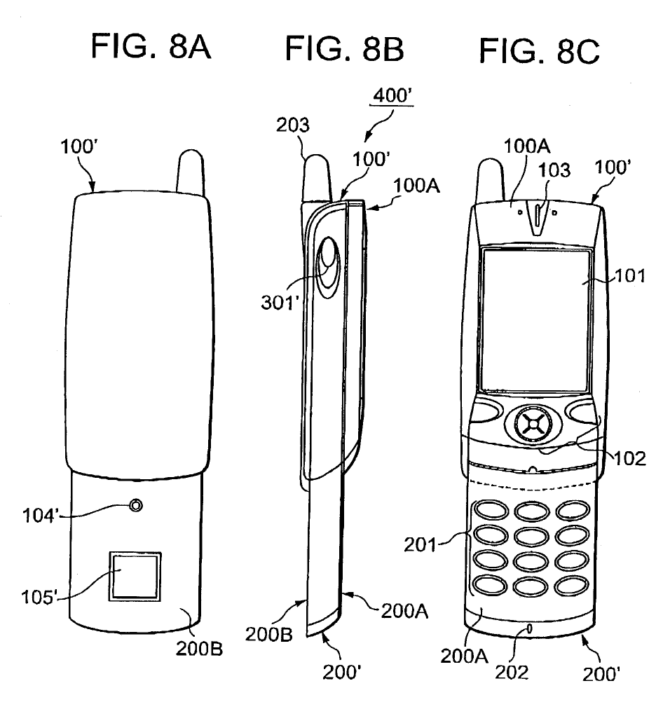

A second embodiment of the present invention will be described with reference to FIGS. 8A-8C, A portable telephone set 400′ according to the second embodiment is composed of two units 100′ and 200′ The first unit 100′ is shaped like a hollow sheath having an opening directed downward and is provided with a display section 101, the secondary operation keys 102, the receiver (speaker) 103 on its surface and further a stop-release operation member 301′ on its side surface. The second unit 200′ is provided with the main operation section 201 and the transmitter (microphone) 202 on its front surface and an image pickup device (CCD camera) 104′ and a fingerprint input section 105′ on its back-side surface. The second unit 200′ can be accommodated within the hollow space of She first unit 100′. These units 100′ and 200′ are coupled via an appropriate slide mechanism so as to be freely slidable in the longitudinal direction.

Further, a magnet 106 (not shown) is disposed at an appropriate position on the first back surface 100B as in the case of the first embodiment. In the display section 101, a touch panel mechanism may be incorporated as necessary. Both units 100′ and 200′ are urged in an extending direction by an urging means (not shown) disposed within the portable telephone set so as to keep the extended state as shown in FIGS. 8A-8E in addition, a stop means (locking mechanism) is provided to lock the units 100′ and 200′ so as to keep the retracted state of the units against the urging means. The locking of the stop means can be released by operating the stop-release operation member 301′ disposed on one of the side surfaces of the first unit 100′. The locking mechanism and the stop-release operation mechanism may be similar to those of the first embodiment.

In this embodiment, when the stop-release operation member 301′ slides, the lock mechanism of the first unit 100′ and second unit 200′ is released to cause the first unit 100′ to automatically slide upward with respect to the second unit 200′ by the urging means and the first unit 100′ is then stopped to the half-opened state. By sliding the stop-release operation member 301′ one more time, the lock mechanism of the first unit 100′ and second unit 200′ is released to cause the first unit 100′ to automatically slide upward with respect to the second unit 200′ by the urging means to set the portable telephone to the extended state as shown in FIGS. 8A-8C. Instead of sliding the stop-release operation member 301′, the stop-release operation member 301′ may be depressed to release the lock mechanism.

The portable telephone according to the present embodiment has the electric circuit similar to that of the first embodiment as shown in FIG. 6 and therefore the detailed descriptions are omitted.

The units 100′ and 200′ are coupled with each other so as to be freely slidable in the axial direction by the slide mechanism. Operating the main operation section 201 and speech communication can be carried out in the extended state that the second unit 200′ is pulled out from the first unit 100′. When the second unit 200′ completely slides into the first unit 100′ (in the retracted state), the main operation section 201 and the optical aperture sections of the electronic image pick-up device 104′ and the fingerprint recognition section 105′ are covered with the back surface of the first unit 100′ and thereby protected. When the second unit 200′ slides into the first unit 100′ at a predetermined midpoint (in the half-opened state) by the first sliding operation of the stop-release operation member 301′, the fingerprint input device 105′ and the lower-half operation keys are exposed (fingerprint registration mode). By the second sliding operation, the portable telephone is changed into the extended state to also expose the image pickup device 104′ (image pickup mode) Accordingly, the function allocation can be changed depending on the stop position of the units 100′ and 200′ as in the case of the first embodiment, achieving the same advantages as those of the first embodiment.

According to the present invention, as described above, the operation function of the main operation section and the secondary operation section is changed depending on a relative position of the front-side unit to the back-side unit. When the portable telephone is carried in the retracted state, the minimum number of input operation functions are provided. In the half-opened state, the intermediate number of input operation functions are provided. In the extended state, the full functions are provided.

1. A slide-type portable apparatus comprising:
a first unit having at least a display section and a secondary operation section;
a second unit having at least a main operation section, wherein the first unit is coupled with the second unit to freely slide in a longitudinal direction between a retracted state and an extended state;
a position detector for detecting a relative position of the first unit and the second unit; and
a function change controller for changing input function allocation to the main operation section and the secondary operation section depending on the relative position.

2. The slide-type portable apparatus according to claim 1, wherein one of the first unit and the second unit further has a tertiary operation section, wherein the function change controller changes input function allocation to at least one of the main operation section, the secondary operation section, and the tertiary operation section depending on the relative position.

3. The slide-type portable apparatus according to claim 1, further comprising:
an urging member for urging the first unit and the second unit in an extension direction; and
a releasable lock mechanism for releasably locking the first unit and the second unit at a desired stop position between the retracted state and the extended state included, wherein the locking is released by a predetermined operation.

4. The slide-type portable apparatus according to claim 3, wherein the releasable lock mechanism releasably locks the first unit and the second unit in one of the retracted state and at least one half-opened state which is positioned between the retracted state and the extended state.

5. The slide-type portable apparatus according to claim 4, wherein one of the first unit and the second unit further has a tertiary operation section, wherein the function change controller changes input function allocation to at least one of the main operation section, the secondary operation section, and the tertiary operation section depending on the relative position.

6. The slide-type portable apparatus according to claim 3, wherein one of the first unit and the second unit further has a tertiary operation section, wherein the tertiary operation section includes a lock-release function of releasing the locking.

7. The slide-type portable apparatus according to claim 1, wherein at least one of the first unit and the second unit further has at least one optical input section exposed, wherein the function change controller changes input function allocation to at least one of the main operation section, the secondary operation section, and the at least one optical input section depending on the relative position.

8. The slide-type portable apparatus according to claim 7, wherein one of the first unit and the second unit has a first optical input section and a second input section placed in the longitudinal direction, wherein the function change controller allocates input function to an exposed one of the main operation section, the first optical input section, and the second input section depending on the relative position.

9. The slide-type portable apparatus according to claim 8, wherein the first optical input section is an optical input section of a fingerprint authentication device and the second input section is an optical aperture of an image pickup device.

10. The slide-type portable apparatus according to claim 9, wherein, when the first optical input section is exposed, a fingerprint input function is allocated to the fingerprint authentication device and, when the second optical input section is exposed, an image pickup function is allocated to the image pickup device.

11. The slide-type portable apparatus according to claim 1, wherein information indicating allocated input functions to the main operation section and the secondary operation section depending on the relative position is displayed on at least one part of the display section.

12. The slide-type portable apparatus according to claim 1, further comprising a speaker which produces sound corresponding to an input operation, wherein a tone color of the sound is changed depending on the relative position.

13. The slide-type portable apparatus according to claim 1, further comprising:
a lighting section for lighting at least one of the main operation section and the secondary operation section from inside; and
a lighting controller for controlling the lighting section depending on input function allocation to the main operation section and the secondary operation section.

14. An input function control method for a slide-type portable apparatus comprising:
a first unit leaving at least a display section and a secondary operation section; and
a second unit having at least a main operation section, wherein the first unit is coupled with the second unit to freely slide in a longitudinal direction between a retracted state and an extended state,
said method comprising the steps of:
detecting a relative position of the first unit and the second unit; and
changing input function allocation to the main operation section and the secondary operation section depending on the relative position.

15. The input function control method according to claim 14, wherein a predetermined input function is allocated to an exposed section of the main operation section and the secondary operation section.

16. The input function control method according to claim 14, wherein an input function allocated to an exposed section of the main operation section and the secondary operation section is different from a normal input function allocated to the main operation section and the secondary operation section in the extended state.
